(19) United States
(12) Patent Application Publication
(10) Pub. No.: US 2025/0053454 A1
(43) Pub. Date: Feb. 13, 2025

(54) METHODS AND APPARATUS FOR A MACHINE LEARNING MODEL DECOMPRESSION ACCELERATOR

(71) Applicant: Intel Corporation, Santa Clara, CA (US)

(72) Inventors: Gerasimos Gerogiannis, Champaign, IL (US); Wim Marcel Ann Heirman, Aalter (BE); Evangelos Georganas, San Jose, CA (US); Stijn Erik D. Eyerman, Evergem (BE)

(73) Assignee: Intel Corporation, Santa Clara, CA (US)

(21) Appl. No.: 18/927,638

(22) Filed: Oct. 25, 2024

(51) Int. Cl. G06F 9/50; G06F 17/16

(52) U.S. Cl. CPC G06F 9/5027; G06F 17/16

(57) ABSTRACT

Systems, apparatus, articles of manufacture, and methods are disclosed for a machine learning model decompression accelerator. An example apparatus includes a processor core including at least one matrix multiplication engine, a memory storing a plurality of tiles of compressed data of a machine learning model to be processed by the at least one matrix multiplication engine; and a decompression accelerator including one or more control registers in communication with the processor core, a processing engine in communication with the memory and configured by the one or more control registers to decompress the plurality of tiles of the compressed data, and an output register to store decompressed data, wherein the processor core is to read the decompressed data from the output register and cause the at least one matrix multiplication engine to perform matrix multiplication with the decompressed data for execution of the machine learning model.

### FIELD OF THE DISCLOSURE

This disclosure relates generally to decompression accelerators and, more particularly, to methods and apparatus for machine learning model decompression accelerators.

### BACKGROUND

Machine learning is a subfield of artificial intelligence. In machine learning, instead of providing explicit instructions, programmers supply data to a model. The model generates predictions and, in some examples, is trained to improve prediction accuracy. Programmers can also adjust model parameters to further improve prediction accuracy. Deep neural network (DNN) models are a type of machine learning model based on artificial neural networks. DNNs can be trained across multiple compute units in a distributed training. In distributed training, a workload is split among multiple compute units: CPUs, GPUs, TPUs, etc.

### BRIEF DESCRIPTION OF THE DRAWINGS

FIG. 1 illustrates a tile of sparse quantized data representative of four compressed weights.

FIG. 2 is a block diagram of an example system in which an example decompression accelerator is integrated with an example processor core to decompress weights for the example processor core to process.

FIG. 3 is an example tile processing scheme that illustrates how the decompression accelerator and the processor core of FIG. 2 operate to efficiently process a weight tile and improve performance of the processor core.

FIG. 4 is a block diagram of an example implementation of the decompression accelerator of FIG. 2.

FIG. 5 is an example decompression accelerator pipeline to illustrate an operation of the decompression accelerator of FIG. 4.

FIGS. 6 and 7 are bar charts illustrating a performance of a core executing an inference workload using software decompression versus using the decompression accelerator of FIGS. 2-4.

FIGS. 8 and 9 are flowcharts representative of example machine readable instructions and/or example operations that may be executed, instantiated, and/or performed by example programmable circuitry to implement the decompression accelerator 202 of FIG. 4.

FIG. 10 is a block diagram of an example processing platform including programmable circuitry structured to execute, instantiate, and/or perform the example machine readable instructions and/or perform the example operations of FIGS. 8 and 9 to implement the decompression accelerator 202 of FIG. 4.

FIG. 11 is a block diagram of an example implementation of the programmable circuitry of FIG. 10.

FIG. 12 is a block diagram of another example implementation of the programmable circuitry of FIG. 10.

In general, the same reference numbers will be used throughout the drawing(s) and accompanying written description to refer to the same or like parts. The figures are not necessarily to scale.

### DETAILED DESCRIPTION

Artificial intelligence models (e.g., machine learning models, deep neural network models, convolutional neural network models, large language models, etc.) have large data sets that require high memory capacity and bandwidth. For example, large language models (LLMs), which perform tasks in an inference phase such as chatbots, translation, text summarization, and content creation, use transformers and consist of multi-head attention and fully connected (FC) layers. Such LLMs contain trillions of parameters, also referred to as weights, in the FC layers. During inference of a model, such as an LLM, the weights are reused infrequently, which increases and/or stresses memory capacity and memory bandwidth of computing platforms (e.g., graphic processing units, central processing units, accelerators, etc.) performing the inference workloads.

To alleviate memory bandwidth bottleneck in model inference workloads, such as LLM inference workloads, and improve the performance of artificial intelligence inference, the models and corresponding parameters go through compression before inference. For example, weights are quantized and sparsified before being sent to a computing platform and stored in memory. However, the compressed models must be decompressed before they can be processed by the hardware (e.g., circuitry in the computing platforms) because the hardware requires dense data in a specific data type to process the weights. For example, some computing platforms comprise matrix multiplication engines that use mathematical operations to process the weights. For the weights to be accurately processed by the matrix multiplication engines, the weights must be dequantized and de-sparsified. As used herein, quantization is the process of reducing the number of bits used to represent the model weights. As used herein, sparsification is the process of not storing weights that are close to zero and/or that have no impact on the model's accuracy. Therefore, dequantization is the process of reintroducing the bits removed during quantization and de-sparsification is the process of reintroducing or adding the weights that are indicative of zero or close to zero.

Currently, decompression is completed in software by the same core that performs inference. Such software uses a complex chain of vector instructions to accomplish the decompression. Vector instructions are a class of instructions that enable parallel processing of data sets. For example, an array of integers or floating point numbers is processed in a single operation, eliminating a loop control mechanism typically found in processing arrays. While vector instructions are used to improve the process of decompression, the performance of a computing platform comprising the core and matrix multiplication engines depends on the interaction between memory resources, vector units, and the matrix multiplication engines. Therefore, such software decompression (e.g., software decompression using vector instructions) has a limited throughput and becomes a bottleneck if its throughput is lower than the memory bandwidth and/or compute throughput. This approach of using the core to execute the software to decompress weights prior to inference delivers a modest performance rather than an improved performance of the computing platform.

Examples disclosed herein describe a decompression accelerator to improve performance of decompression and, thus, performance of computing platforms during inference. The example decompression accelerator disclosed herein is integrated with a core (e.g., computing platform) that supports matrix multiplication engines. The example decompression accelerator fetches compressed weights and decompresses the weights from the core, enabling parallel decompression and matrix multiplication. For example, the decompression accelerator offloads weight de-sparsification and dequantization from the core (e.g., CPU) and generates compatible weights for the core to process while the core executes arithmetic operations with decompressed weights. A throughput of the example decompression accelerator can be controlled by dimensioning the decompression accelerator resources, enabling efficient balanced designs for each memory and core bandwidth configuration. Because the example decompression accelerator performs decompression of compressed weight tiles, a portion of a load on the core performing inference of the weight tiles is offloaded, which improves throughput of the core. Additionally, the example decompression accelerator disclosed herein improves the bandwidth and latency of decompression by fetching tiles of compressed data from the level two cache of the core performing inference.

As used herein, a “core” or a “compute unit” is a single processing unit within the computing platform (e.g., CPU, GPU, FPGA, etc.) that can execute instructions (e.g., model inference instructions). For example, the core is Intel® Tile Matrix Multiplication Engine (TMUL) that is implemented by Intel® Advanced Matrix Extension (Intel® AMX) dedicated hardware block found on the Intel® Xeon® Scalable processor core.

As used herein, a “tile” refers to a data set divided based on a number of weights in the data set. For example, a layer in a model may have 100 weights, and a tile may divide that layer into two weights per tile, depending on the amount of bits representing the weights. As used herein, a tile has n rows and W elements per row. In examples disclosed herein, a tile can hold up to 16 rows (e.g., n=16), with 64 bytes of data per row, and 1 KB of data total in the tile. However, any format and/or configuration of tile can be used in examples disclosed herein. In examples disclosed herein, when a tile includes elements having one byte of data, W is equal to 64, and when a tile includes elements having two bytes of data, W is equal to 32.

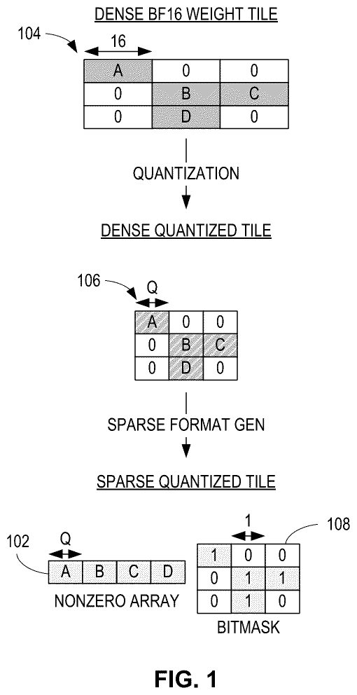

In examples disclosed herein, a tile represents at least one compressed weight that is to be decompressed by the decompression accelerator. For example, FIG. 1 illustrates a sparse quantized tile 102 representative of four compressed weights [a, b, c, d]. As used herein, a “tile of sparse quantized data” is equivalent to a “tile of compressed data.” In FIG. 1, the sparse quantized tile 102 began as a dense weight tile 104. The dense weight tile 104 of FIG. 1 has non zero weights [a, b, c, d] and zero or near zero weights, where each non zero weight has a first number of bits.

A compression model (not illustrated) quantizes the dense weight tile 104 and generates a dense quantized tile 106. Quantization is the process of reducing the first number of bits to a second number of bits, less than the first number of bits. For example, the first number of bits in the dense weight tile 104 are in a 16 bit form (e.g., BF16 format), where an integer value representative of the weight occupies 16 bits of computer memory. The process of quantization reduces the 16 bits to a number of Q bits.

Lastly, the compression model sparsifies the dense quantized tile 106 to generate the sparse quantized tile 102. Sparsification is the process of removing or “pruning” the zero or near zero weights and generating a bitmask 108. The bitmask 108 denotes a status or an existence of a weight in a tile. For example, the bitmask 108 denotes positions in the tile where weight a, weight b, weight c, and weight d are located, as well as denoting the positions in the tile where the near zero weights are located. In some examples, bitmasks 108 are used by decompression circuitry to reintroduce zeros into the tile (e.g., the sparse quantized tile 102).

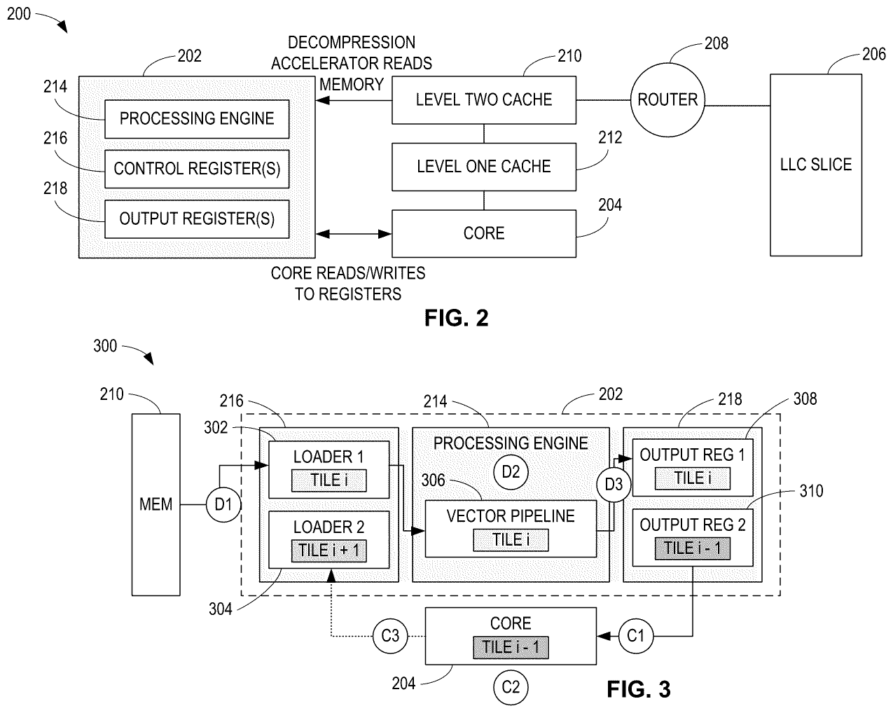

FIG. 2 is a block diagram of an example system 200 in which an example decompression accelerator 202 is integrated with an example core 204 to decompress weights for the example core 204 to process. The example system 200 includes an example last level cache slice 206, an example router 208, an example level two cache 210, and an example level one cache 212. The example decompression accelerator 202 includes an example processing engine 214, example control register(s) 216, and example output register(s) 218.

In FIG. 2, the system 200 may represent a portion of a processor platform, such as a central processing unit (CPU), and each processor platform may include a plurality of systems 200. For example, a processor platform includes a plurality of cores and, thus, a plurality of decompression accelerators 202. In such an example, the last level cache slice 206 is a portion of a last level cache that is mapped to a specific range of memory addresses and can be accessed independently. The last level cache is the highest level cache in a processor platform and is shared among a plurality of cores, including the core 204. The level two cache 210 is a cache that is smaller than the last level cache and is located between the last level cache and the level one cache 212. The level one cache 212 is a smaller cache, relative to the level two cache 210 and the last level cache, and is located closest to the core 204. The level one cache 212 is fast memory that stores the most frequently used data and instructions. The level two cache 210 stores data that is accessed less frequently and is slightly slower than the level one cache 212, but faster than access to the last level cache. The decompression accelerator 202 shares the level two cache 210 with the core 204 and, therefore, uses virtual space of the core 204.

In FIG. 2, the system 200 includes the decompression accelerator 202 to decompress weights fetched from the level two cache 210. To fetch and decompress the weights, the decompression accelerator 202 includes the processing engine 214 and the control registers 216. The decompression accelerator 202 includes the output registers 218 to enable the core 204 to read and write from the decompression accelerator 202.

The core 204 uses the control registers 216 to configure the processing engine 214 to perform decompression of tiles with a given quantization scheme and with or without sparsity. The control registers 216 are processor registers that change or control the general behavior of a processing element or other digital device. For example, the core 204 uses the control registers 216 to interface with the decompression accelerator 202. In some examples, the core 204 uses Tile External Preprocess and Load (TEPL) instructions to instruct the decompression accelerator 202. For example, the core 204 sends an instruction that updates the control registers 216 with metadata of a tile, which triggers the decompression accelerator 202 to fetch a tile from the level two cache 210, and causes the core 204 to only return to the decompression accelerator 202 when the tile has been decompressed and stored in an output register 218. In some examples, this instruction (e.g., TEPL instruction) combines two instructions into one: sending data addresses (e.g., metadata) and loading the data (e.g., retrieving and storing the decompressed tile). To the core 204, the TEPL instruction is equivalent to a normal load instruction, where it can be executed speculatively and out of order. The instruction is complete when the data (e.g., the decompressed tile) is available (e.g., stored) in the output registers 218. The updating of the control registers 216 with metadata of a tile is not a part of the architectural state of the decompression accelerator 202 because it is just used to start a decompression operation. Therefore, in case the decompression operation needs to be squashed (e.g., due to a mis-speculation or interrupt), the decompression operation is simply stopped without needing to save any state. If the decompression operation is relaunched, the decompression operation.

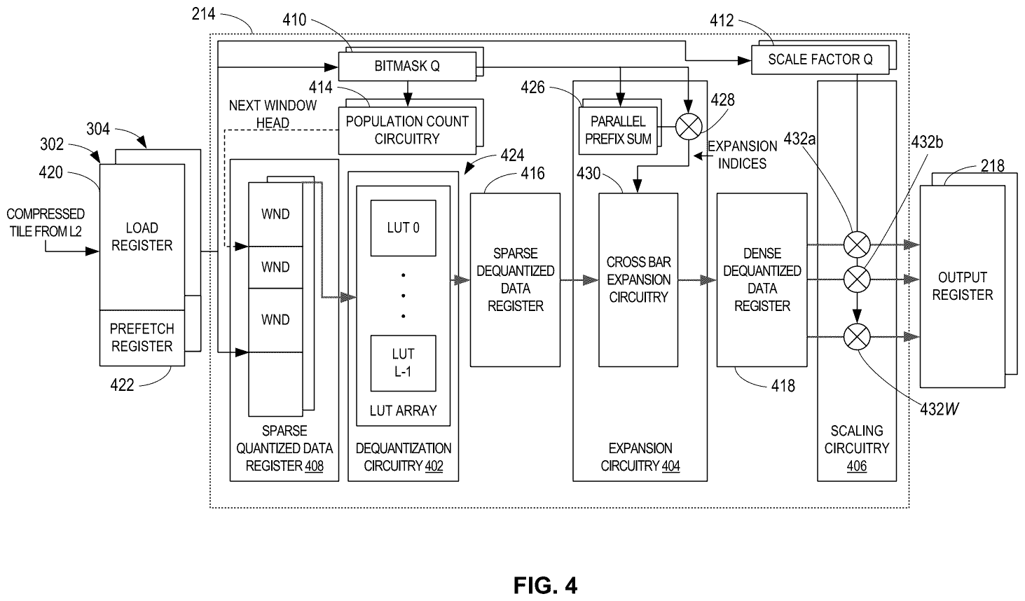

In some examples, the core 204 uses the control registers 216 to configure lookup tables (LUTs) that the decompression accelerator 202 utilizes for dequantization. In some examples, the core 204 uses the TEPL instructions and control registers 216 to implement double buffering, which increases overlap (e.g., parallel operations) between decompression operations and matrix multiplication operations (e.g., tile processing). For example, while the decompression accelerator 202 decompresses a tile, the decompression accelerator 202 starts loading data for the next decompression operation. When the decompression of the first tile is complete, the decompression accelerator 202 begins decompressing the next tile. As a result, the core 204 and corresponding matrix multiplication engines process the first decompressed tile, while the decompression accelerator 202 decompresses the next tile. The double buffering operation of the decompression accelerator 202 is described in further detail below in connection with FIG. 3.

The processing engine 214 reads a tile of compressed data from memory (e.g., last level cache slice 206), processes the tile (e.g., decompresses the tile), and then writes the tile of decompressed data to the output registers 218. The processing engine 214 accesses the memory through the level two cache 210. The processing engine 214 issues regular loads and prefetch requests, where the regular loads refer to reading data (e.g., a tile of compressed data) from memory that is to be decompressed and the prefetch requests refer to reading data, that is to be decompressed next, in advance. The processing engine 214 is described in further detail below in connection with FIGS. 3, 4, and 5.

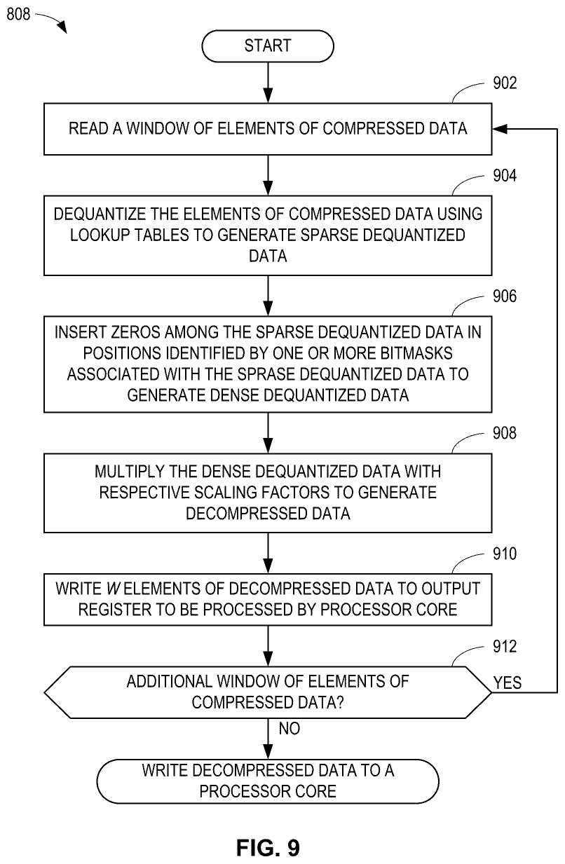

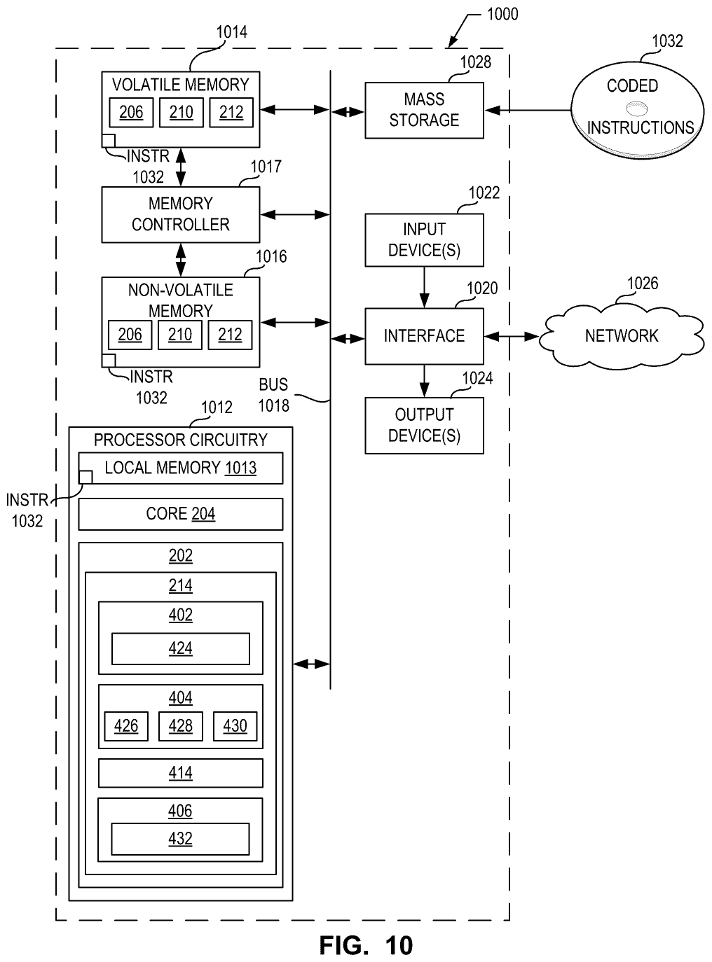

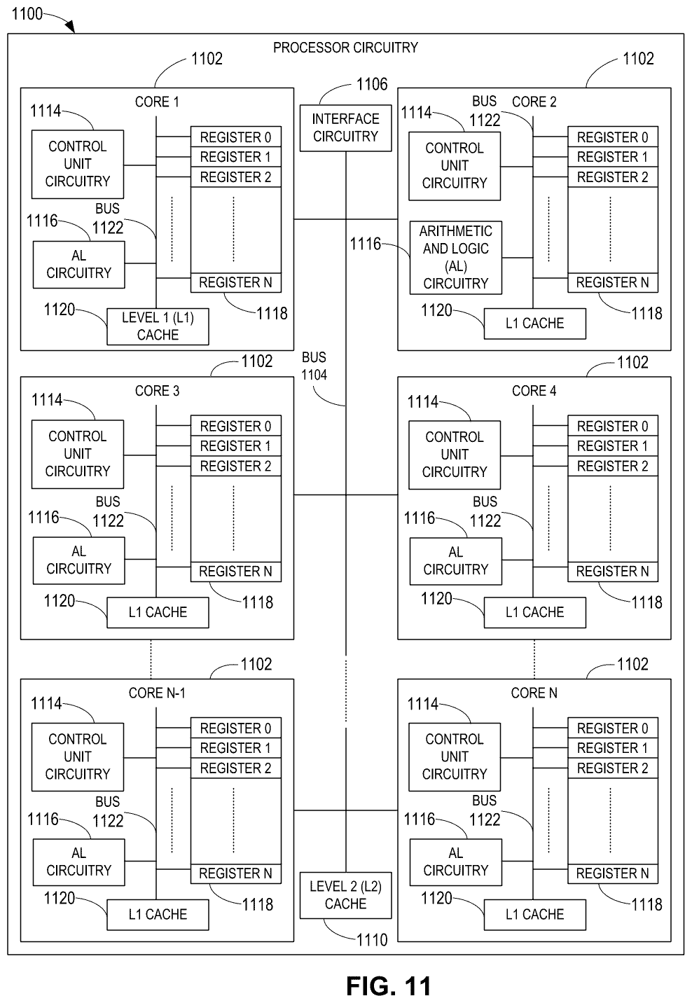

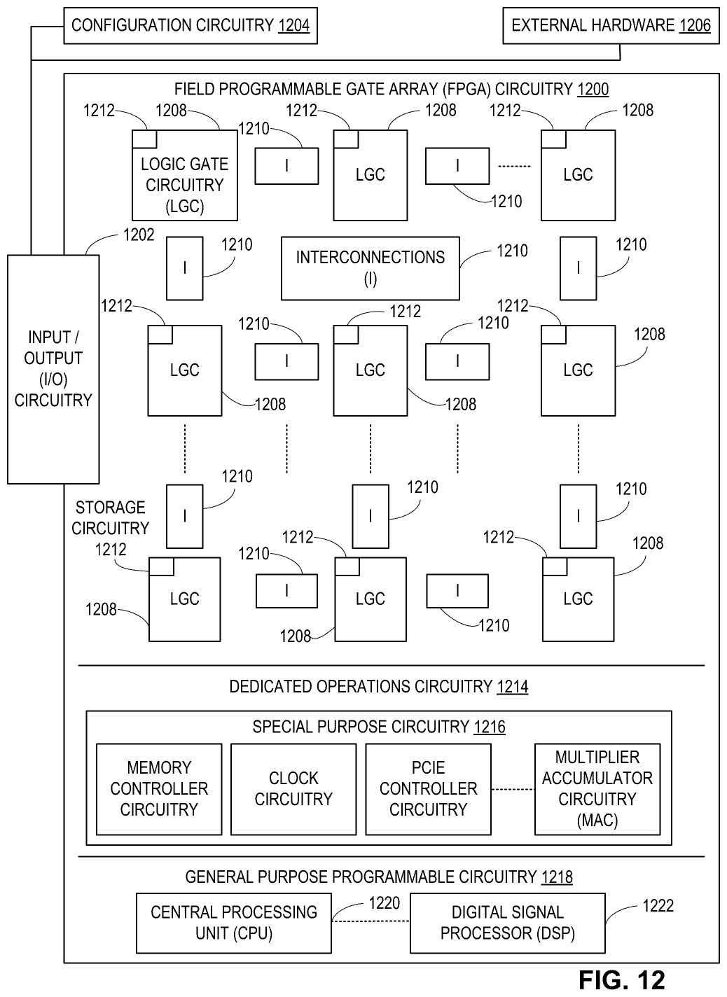

In some examples, the decompression accelerator 202 includes means for decompressing tiles of compressed data indicative of weights of a machine learning model. For example, the means for decompressing tiles of compressed data indicative of weights of a machine learning model may be implemented by processing engine circuitry 214. In some examples, the processing engine circuitry 214 may be instantiated by programmable circuitry such as the example programmable circuitry 1012 of FIG. 10. For instance, the processing engine circuitry 214 may be instantiated by the example microprocessor 1100 of FIG. 11 executing machine executable instructions such as those implemented by at least block 814 of FIG. 8 and blocks 902, 904, 906, 908, and 910 of FIG. 9. In some examples, the processing engine circuitry 214 may be instantiated by hardware logic circuitry, which may be implemented by an ASIC, XPU, or the FPGA circuitry 1200 of FIG. 12 configured and/or structured to perform operations corresponding to the machine readable instructions. Additionally or alternatively, the processing engine circuitry 214 may be instantiated by any other combination of hardware, software, and/or firmware. For example, the processing engine circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the means for decompressing tiles of compressed data indicative of weights of a machine learning model includes means for dequantizing compressed weights using a lookup table. In some examples, the means for decompressing tiles of compressed data indicative of weights of a machine learning model includes means for generating dense dequantized data by inserting zeros among the sparse dequantized data. In some examples, the means for decompressing tiles of compressed data indicative of weights of a machine learning model includes means for multiplying the dense dequantized data with scaling factors associated with the sparse dequantized data and write the decompressed output tile to the output register.

In FIG. 2, the system 200 includes the core 204, which is a single processing unit within a computing platform that executes model inference instructions, such as matrix multiplication, to process weights. A performance of the core 204 is important when processing weights. The performance of the core 204 can be determined in teraflops per second (TFLOPS). A TFLOP is a core's 204 capability to calculate one trillion floating-point operations per second. The greater the number of TFLOPs that the core 204 can perform, the lesser the likelihood that a bottleneck in bandwidth will occur when the core 204 processes weights. However, with AI models containing trillions of parameters (weights), a bottleneck in bandwidth during inference is inevitable, no matter how many TFLOPs the core 204 can perform. Therefore, the core 204 is in communication with the decompression accelerator 202 to reduce the number of decompression operations that the core 204 has to perform to execute an inference workload and, thus, eliminate the bottleneck in bandwidth and increase throughput.

In FIG. 2, the system 200 includes the router 208 to route data, such as weights, from the last level cache slice 206 to the level two cache 210. In some examples, the router 208 is connected to a memory controller and facilitates reading, writing, moving, and deleting data from the last level cache 206.

FIG. 3 is an example tile processing scheme 300 that illustrates how the decompression accelerator 202 and the core 204 operate to efficiently process a weight tile and improve performance of the core 204. For example, the tile processing scheme 300 overlaps decompression operations (e.g., vector operations) with inference operations (e.g., matrix multiplication operations) using hardware double buffering to make processing more efficient (e.g., fast, etc.).

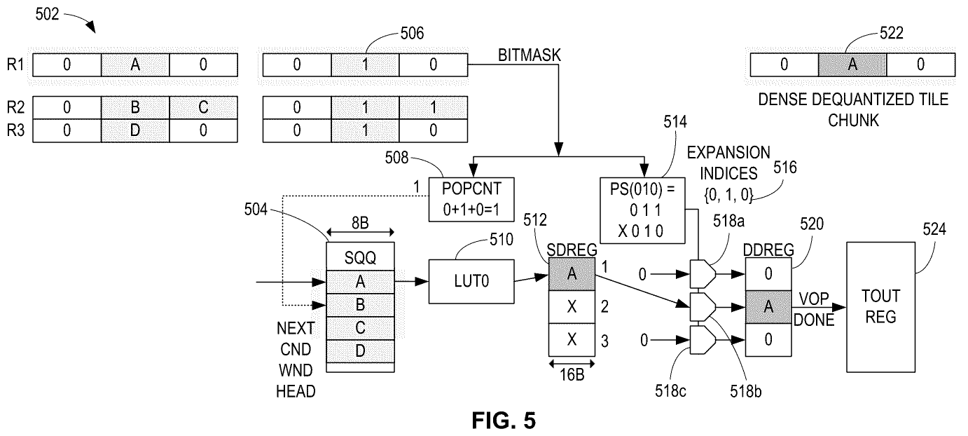

In FIG. 3, the tile processing scheme 300 illustrates the control registers 216 including an example first loader 302 and an example second loader 304. The tile processing scheme 300 illustrates the processing engine 214 at a higher level. For example, the processing engine 214 includes an example vector pipeline 306. For the purposes of describing the tile processing scheme 300, a description of the vector pipeline 306 is high level. However, the vector pipeline 306 is described in further detail below in connection with FIG. 4. In FIG. 3, the tile processing scheme 300 illustrates the output registers 218 including an example first output register 308 and an example second output register 310.

In FIG. 3, the first loader 302 issues regular load requests (e.g., reading a tile of compressed data from memory that is to be decompressed) to the level two cache 210. In some examples, the first loader 302 is a memory buffer register that temporarily stores data fetched from memory. In this example, the first loader 302 reads a first tile (Tile i) from the level two cache 210. Tile i, and any other tile, includes three data structures. The three data structures are the data, the bitmask, and the scaling factors. In this example, the data may be the sparse quantized tile 102 (FIG. 1), the bitmask may be the bitmask 108 (FIG. 1), and the scaling factors may be factors indicative of quantization (e.g., what factors were used to reduce the 16 bits of the non-zero weights in the dense weight tile 104 to a number of Q bits). In some examples, the core 204 sends instructions to the first loader 302 to read the tile of compressed data from the level two cache 210. For example, the core 204 sends the first loader 302 metadata of the tile, including a starting address of a location in the last level cache 206 and the length of the three data structures of Tile i.

In FIG. 3, the second loader 304 operates the same as the first loader 302. The second loader 304 issues regular requests to the level two cache 210. In this example, the second loader 304 reads Tile i+1 from the level two cache 210. Tile i+1 includes the three data structures. In some examples, the core 204 sends instructions to the second loader 304 to read the tile of compressed data from the level two cache 210. For example, the core 204 sends the second loader 304 metadata of Tile i+1, including a starting address of a location in the last level cache 206 and the length of the three data structures of Tile i+1.

In some examples, both the first loader 302 and second loader 304 issue prefetch requests to a last level cache, to bring tile data to the level two cache 210. The prefetch requests are predictions of next tiles to decompress based on the metadata of previous tiles read from the level two cache 210. For example, the core 204 may instruct the first loader 302 to read Tile i, Tile i+2, and Tile i+4, and the first loader 302 may predict the metadata for Tile i+6 based on Tiles i, i+2, and i+4. Similarly, the core 204 may instruct the second loader 304 to read Tile i−1, Tile i+1, and Tile i+3, and the second loader 304 may predict the metadata for Tile i+5 based on Tiles i−1, i+1, and i+3. In response to the prefetch request, the first loader 302 and/or the second loader 304 causes the last level cache (not shown) to send the tile corresponding to the tile metadata to the level two cache 210. For example, the second loader 304 sends a request to the last level cache for a Tile i+5. The last level cache writes the data (e.g., Tile i+5 and metadata of Tile i+5) to the level two cache 210, and the second loader 304 accesses the data from the level two cache 210.

In some examples, the vector pipeline 306 reads the tile (Tile i+1) from the second loader 304 while the first loader 302 reads the next tile (Tile i+2) from the level two cache 210. In such an example, hardware double buffering is implemented by the first loader 302 and the second loader 304.

In FIG. 3, the vector pipeline 306 reads the first tile (Tile i) from the first loader 302 and decompresses the first tile (Tile i). For example, the vector pipeline 306 uses the bitmask and the scaling factors (e.g., the metadata) to reintroduce zeros into the compressed data and resize/dequantize the compressed data. The vector pipeline 306 stores the decompressed data of Tile i in the first output register 308.

In FIG. 3, the first output register 308 stores the decompressed data of Tile i. The first output register 308 may be implemented by any type of register that is accessible by the core 204. In some examples, the first output register 308 is a memory buffer register.

In FIG. 3, the second output register 310 stores a third tile (Tile i−1) of decompressed data. The Tile i−1 is a tile of data that was decompressed before the first tile (Tile i) of data was decompressed. As such, the third tile (Tile i−1) of decompressed data is processed by the core 204 before the first tile (Tile i) is processed. In some examples, the second output register 310 is a memory buffer register that implements, along with the first and second loaders 302, 304 and the first output register 308, hardware double buffering in the tile processing scheme 300.

The example tile processing scheme 300 is now described in operations D1 to D3 and operations C1 to C3. At operation D1, the decompression accelerator 202 loads the first tile (Tile i) into the first loader 302. For example, the first loader 302 receives an instruction from the core 204 with a starting address and the length of three data structures of the first tile.

At operation D2, the vector pipeline 306 decompresses the first tile (Tile i). For example, the vector pipeline 306 uses the bitmask to reintroduce zeros into the compressed weight tile (e.g., Tile i) and the scaling factors to dequantize the compressed weight tile.

At operation D3, the vector pipeline 306 stores the decompressed first tile into the first output register 308. For example, after decompression, the first output register 308 receives and stores the dense weight tile.

While operations D1-D3 occur, operations C1-C3 occur. At operation C1, the core 204 reads the third tile (Tile i−1) of compressed data from the second output register 310.

At operation C2, the core 204 uses the third tile of decompressed data to perform a matrix multiplication operation. For example, the core 204 may use the third tile (T i−1) of decompressed data to calculate a weighted value of an input (not shown) to an AI model. For example, an AI model includes weights (e.g., tiles) that are used to extract features from an input that eventually are used to generate an output.

At operation C3, the core 204 prompts the second loader 304 to initiate the fetching of the next tile (Tile i+1) by passing the starting address and the length of the three data structures of the second tile (Tile i+1). For example, after the core 204 performs an operation with the third tile (Tile i−1) of decompressed data, the core 204 instructs the second loader 304 to issue a request to the level two cache 210.

In some examples, the first loader and second loader 304 record regular access patterns issued for previous tiles and predict which data to prefetch from the last level cache. For example, the second loader 304 observes the address bases and lengths used for the Tile i−1, and Tile i+1 and uses the address bases and lengths to predict address bases and lengths for Tile i+3, Tile i+5, Tile i+7, etc. In some examples, the second loader 304 can predict address bases and lengths in advance because the tiles are assigned to the same loader (e.g., the first loader 302).

As shown in the tile processing scheme 300, the first and second loaders 302, 304 allow the overlapping of the operations (e.g., decompression and processing) on two tiles (e.g., Tile i and Tile i−1). For example, while the core 204 is reading and processing tile Ti−1, the decompression accelerator 202 reads, processes, and writes out Tile i. After the core 204 finishes processing Tile i−1, the core 204 triggers the fetching of Tile i+1 while the decompression accelerator 202 processes Tile i.

FIG. 4 is a block diagram of an example implementation of the decompression accelerator 202 of FIG. 1 to decompress a tile. The decompression accelerator 202 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the decompression accelerator 202 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

In FIG. 4, the decompression accelerator 202 includes the control registers 216, the processing engine 214, and the output registers 218. In FIG. 4, the processing engine 214 includes example dequantization circuitry 402, example expansion circuitry 404, example scaling circuitry 406, an example sparse quantized data register 408, an example bitmask queue 410, an example scale factor queue 412, example population count circuitry 414, an example sparse dequantized data register 416, and an example dense dequantized data register 418. In FIG. 4, the control registers 216 includes an example load register 420 and an example prefetch register 422.

In some examples, the dequantization circuitry 402 is instantiated by programmable circuitry executing dequantization instructions and/or configured to perform operations such as those represented by the flowcharts of FIGS. 8 and 9. In some examples, the expansion circuitry 404 is instantiated by programmable circuitry executing expansion instructions and/or configured to perform operations such as those represented by the flowcharts of FIGS. 8 and 9. In some examples, the scaling circuitry 406 is instantiated by programmable circuitry executing scaling instructions and/or configured to perform operations such as those represented by the flowcharts of FIGS. 8 and 9.

In some examples, the load register 420 is implemented by loader circuitry. As used herein, “load register” and “loader circuitry” are used interchangeably. As used herein, “prefetch register” and “prefetch circuitry” are used interchangeably. In some examples, the load register 420 and the prefetch register 422 are implemented by the first loader 302 or the second loader 304 of FIG. 3. For example, each loader (e.g., first loader 302 and second loader 304) has a load register 420 and a prefetch register 422. In some examples, the control registers 216 include more than one load register 420 and more than one prefetch register 422. In this example, the load register 420 and the prefetch register 422 operate the same as the second loader 304. For example, the load register 420 reads tiles of compressed data from a level two cache (not shown) based on information (e.g., tile addresses and tile metadata lengths) provided by a core (not shown). The prefetch register 422 obtains and observes addresses of tiles of compressed data at the load register 420, predicts next addresses of next tiles of compressed data, and brings the compressed data from main memory to the level two cache based on the predicted addresses (e.g., and tile metadata lengths).

In some examples, the output registers 218 are implemented by the first and second output registers 308 and 310 of FIG. 3. For example, the output registers 218 store tiles of decompressed data and is accessed by a core executing operations on the tiles of decompressed data.

In FIG. 4, the processing engine 214 includes the dequantization circuitry 402 to dequantize values from the sparse quantized queue 408 using an array of lookup tables (LUT array) 424. The sparse quantized queue 408 is a data register that manages tiles of compressed weights read from a level two cache by the load register 420. As used herein, “sparse quantized queue” and “sparse quantized data register” may be used interchangeably.

In the sparse quantized data register 408, the tile of compressed weights is split into operation windows (Wnds) of elements, because the decompression accelerator 202 decompresses the weights to produce chunks of W elements. As described above and reiterated here, a tile has n rows and W elements per row. The number of W elements in a row may be different than the number of elements in an operation window that are used to denote the current decompression size. Each W element can hold a certain number of bits (e.g., 1 bit, 1 byte (8 bits), 2 bytes (16 bits), etc.). In some examples, one weight may use all the storage that a W element can provide, such that the weight consists of 1 byte of data, 2 bytes of data, 3 bytes of data, etc. For example, weights [a, b, c, d] of FIG. 1 each have one byte of data such that in a first row, weight “a” is in a first element, weight “b” is in a second element, weight “c” is in a third element, and weight “d” is in a fourth element. In some examples, one weight may use less bits than a W element can provide (e.g., 4 bits in a 1 byte element, zero bits, etc.). For example, when data is sparse, due to sparsification during compression, less than W elements in an n row might be needed to decompress a chunk.

The processing engine 214 includes the population count circuitry 414 to count a number of 1 bits in a data set to denote the current operation window (Wnd) of one or more elements that needs to be decompressed. For example, because a tile of compressed data is sparse (e.g., not all W elements in a row are used to hold the weights), the population count circuitry 414 uses a bitmask (e.g., bitmask 108) to inform the dequantization circuitry 402 where the next nonzero element is. For example, the population count circuitry 414 counts the number of 1's (i.e., the number of nonzeros) in the next W bits of the bitmask and uses this count to denote the current operation window (Wnd) of weights needed to decompress the next chunk.

In FIG. 4, the dequantization circuitry 402 uses the LUT array 424 to dequantize a chunk of W elements. A lookup table is an array of data that maps input values to output values, thereby approximating some function (e.g., quantization). The LUT array 424 includes L lookup tables, where one lookup table supports up to 8-bit quantized numbers, which can represent 256 different values. For example, in FIG. 1, the dense weight tile 104 was a first number of bits in a 16 bit form (e.g., BF16 format), and the compression model reduced that first number of bits to a second number of Q bits. In this example, the second number of Q bits may be 8 bits, causing the dense quantized weight tile 106 to have 8-bit quantized numbers. In some examples, Q could be 6, 4, etc. In this example, each of the L LUTs in the LUT array 424 stores 256 (2\hat{ }8) BF16 values, and each of the L LUTs have an LUT address representative of an 8-bit value. Therefore, dequantizing an 8-bit value corresponds to a lookup using the 8-bit value as the LUT address. However, the lookup tables in the LUT array 424 may be used to dequantize any bit size format of the compressed data. For example, the lookup tables may be used to dequantize a 6-bit value, a 4-bit value, etc.

In FIG. 4, the dequantization circuitry 402 includes a plurality of L LUTs to allow for parallel dequantization of multiple values. The core 204 configures the contents of the LUTs and covers any 1 to 8-bit quantization format. For example, to reduce complexity of the LUTs and to enable higher throughput for lower bit quantization (e.g., 6-bit quantized values, 4-bit quantized values, etc.), the core 204 splits each LUT in the LUT array 424 into four 64 (2⁶) entry LUTs that can be accessed in parallel. Splitting the LUTs in this way quadruples the throughput for 6-bit and lower quantization. For example, if the quantized data bit width is 6 bits or less, the four sub-LUTs can be used in isolation to enable 4 reads from one 256-entry LUT.

To limit an area size of the processing engine 214 and, thus, the decompression accelerator 202, a number of LUTs for the LUT array 424 is chosen based on the number of W elements in a tile. For example, to keep an area size of the decompression accelerator 202 small, the number of lookup tables is small.

In FIG. 4, The processing engine 214 includes the sparse dequantized data register 416 to store dequantized data. The dequantization circuitry 402 writes dequantized values (e.g., BF16 values) to the sparse dequantized data register 416. The sparse dequantized data register 416 can store up to W elements. In some examples, when a tile includes sparse data, the sparse dequantized data register 416 stores less than W elements.

In FIG. 4, the expansion circuitry 404 uses a bitmask to make the dequantized data dense. The bitmask queue 410 stores the bitmask for the tile currently being decompressed. To make the dequantized data dense, the expansion circuitry 404 inserts zeros at correct places in the data, such that the output of the expansion circuitry 404 is a dense dequantized tile that can be processed by the core 204. The expansion circuitry 404 inserts zeros at correct places in the data by calculating a parallel prefix sum from the bitmask using example parallel prefix sum circuitry 426. A parallel prefix sum is a technique used to compute prefix sums efficiently in parallel computing environments. The prefix sum for an array is an array, where each element is the sum of all preceding elements in the original array. When a prefix sum is calculated in parallel, the sums of the elements are not determined sequentially, one by one. Instead, multiple processors are used to compute the prefix sum. Therefore, the prefix sum circuitry 426 may implemented by more than one processor.

The prefix sum circuitry 426 determines a number of nonzeros in the bitmask, which can be used to indicate the locations of the nonzeros when multiplied with the bitmask. The processing engine 214 includes an example multiplier 428 to multiply the prefix sum of the bitmask by the bitmask array. The result of multiplying the prefix sum by the bitmask array is expansion indices. Expansion indices indicate where the zeros and nonzeros should be placed in the decompressed tile. The expansion indices contain a zero on the zero locations, a 1 for the first nonzero element, a 2 for the second nonzero element, etc.

The expansion circuitry 404 includes example cross bar expansion circuitry 430 to route non-zeros to correct locations in the sparse dequantized data. The cross bar expansion circuitry 430 routes and/or inserts non-zeros to the locations in the decompressed tile indicated by the expansion indices. In some examples, the cross bar expansion circuitry 430 sets the other remaining locations in the dense dequantized data register 418 to zero.

In FIG. 4, the processing engine 214 includes the dense dequantized data register 418 to hold the expanded data. For example, the expansion circuitry 404 writes the dense dequantized data to the dense dequantized data register 418.

In FIG. 4, the decompression accelerator 202 includes the scaling circuitry 406 to apply scaling to values in the dense dequantized data register 418. The scaling circuitry 406 includes multipliers 432a-432W. The multipliers 432a-432W scale the values in the dense dequantized data register 418 by multiplying each element with the scaling factor. The scale factor queue 412 stores the scale factor and is accessed by the multipliers 432a-432W when values are added to the dense dequantized data register 418. In some examples, the multipliers 432a-432W are BF16 multipliers. Additionally and/or alternatively, the multipliers 432a-432W are exponential adders. In some examples, the scale factor is provided by the core 204 as metadata with the tile of compressed weights.

In FIG. 4, the scaling circuitry 406 writes the final values to the output register 218. In some examples, the final values are representative of decompressed data and are stored in chunks of W elements, because that is how the decompression accelerator 202 decompressed a tile. When the complete tile is decompressed, the tile of decompressed data is transferred to a core tile register at the core 204, where it can be consumed by a matrix multiplication operation.

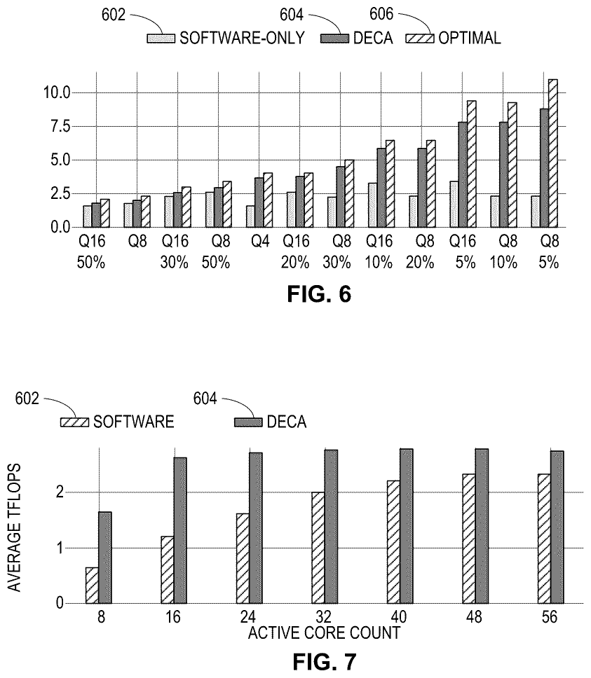

FIG. 5 is an example decompression accelerator pipeline 500 to illustrate an operation of the decompression accelerator 202 of FIG. 4. The decompression accelerator pipeline 500 includes an example weight tile 502 that is a part of a layer of an AI model that is to be used to process an input to the AI model. The weight tile 502 has three rows (R1, R2, R3) having three elements each, such that W=3. The decompression accelerator pipeline 500 processes a compressed version of the weight tile 502 in chunks of three, starting with row R1. Therefore, the decompression accelerator pipeline 500 of FIG. 5 depicts processing of row R1, but omits the remaining processing of rows R2 and R3 for the sake of brevity and redundancy.

In FIG. 5, the decompression accelerator pipeline 500 includes an example sparse quantized data register 504 that stores sparse quantized data representative of weight tile 502 of compressed data. The sparse quantized data register 504 stores the quantized nonzero elements of the weight tile 502. For example, the elements of the weight tile 502 may hold values in 16 bit form (e.g., BF16 format), where an integer value representative of the weight occupies 16 bits of computer memory. Quantized values may be in 8 bit form. Therefore, the sparse quantized data register 504 stores nonzero elements of the weight tile 502 in 8 bits of memory. For example, weight [a] in row R1 (the only nonzero element in row R1) is quantized during compression and stored in 8 bits. The sparse quantized data register 504 may be implemented by the sparse quantized data register 408 of FIG. 4.

In FIG. 5, the decompression accelerator pipeline 500 includes an example bitmask 506 to denote a status or an existence of a weight in the weight tile 502. For example, the bitmask 506 denotes positions in the tile 502 where weight a, weight b, weight c, and weight d are located, as well as denoting the positions in the tile 502 where the zero weights are located. The bitmask 506 is an array having a same number of rows and elements as the weight tile 502, and denotes positions by using a logic “1” to represent where in the array a nonzero value is and a logic “0” to represent where in the array a zero or near value is.

In FIG. 5, the decompression accelerator pipeline 500 includes population count circuitry 508 to count a number of 1 bits in the bitmask 506 to denote the current element in the sparse quantized data register 504 that needs to be decompressed. For example, the population count circuitry 508 counts the number of 1's in the next W bits of the bitmask 506 and uses this count to denote the current operation window in the sparse quantized data register 504. In some examples, the population count circuitry 508 controls how the processing engine 214 selects which weight to process. For example, the population count circuitry 508 controls a vector operations pointer that points to the address in the sparse quantized data register 504 that processing engine 214 is to process next. In some examples, the population count circuitry 508 is implemented by the population count circuitry 414 of FIG. 4.

In FIG. 5, the decompression accelerator pipeline 500 includes a lookup table array 510 to dequantize a weight. In this example, the decompression accelerator 202 includes one lookup table array 510, making L=1. The lookup table array 510 provides a dequantized value for whatever quantized value is currently being processed. The lookup table array 510 writes the dequantized value to an example sparse dequantized register data 512. In some examples, the lookup table array 510 is implemented by the LUT array 424 of FIG. 4.

In FIG. 5, the decompression accelerator pipeline 500 includes the sparse dequantized data register 512 to store outputs of lookup tables. For example, the sparse dequantized data register 512 stores W elements. The elements are stored in a 16 bit format, because the lookup table outputs a 16 bit dequantized value of an 8 bit quantized value. In some examples, the sparse dequantized data register 512 is implemented by the sparse dequantized data register 416 of FIG. 4.

In FIG. 5, the decompression accelerator pipeline 500 includes example prefix sum circuitry 514 to expand (e.g., insert zeros into) the W chunk of data. For example, the prefix sum circuitry 514 generates expansion indices 516 based on the bitmask 506, which provide information as to where in the row a zero should be. In some examples, the expansion indices 516 are used to control example multiplexers 518a, 518b, and 518c. For example, the expansion indices 516 provide multiplexers 518a, 518b, and 518c with input values of zero or a positive integer, where an input of zero causes the multiplexer 518 to output a zero to an example dense dequantized data register 520 and an input of an integer causes the multiplexer 518 to output whatever value is in that location in the sparse dequantized data register 512. In some examples, the expansion indices 516 provide an order for which multiplexer 518a, 518b, and 518c is to output what value, because the multiplexers 518a, 518b, and 518c are associated with specific addresses in the dense dequantized data register 520. The prefix sum circuitry 514 generates the expansion indices 516 by multiplying the prefix sum with the bitmask.

In FIG. 5, the decompression accelerator pipeline 500 includes the example dense dequantized data register 520 to store a dense dequantized chunk 522. The dense dequantized chunk 522 is equivalent to the data in row R1 of the weight tile 502. In some examples, the dense dequantized data register 520 is implemented by the dense dequantized data register 418 of FIG. 4.

An example operation of the decompression accelerator pipeline 500 begins when the population count circuitry 508 points to an operation window in the sparse quantized data register 504 that contains data to be decompressed. In this example, the data to be decompressed is weight [a] in row R1 of the weight tile 502. The population count circuitry 508 counts the number of ones in a first row of the bitmask 506 to identify the operation window in the sparse quantized data register 504.

Next, the lookup table array 510 uses the quantized value of weight [a] to lookup a dequantized value of weight [a] and stores that dequantized value in the sparse dequantized data register 512. Because weight [a] is the only nonzero weight in the first chunk, the sparse dequantized data register 512 stores the dequantized value of weight [a] and leaves the other two addresses empty. However, if the population count circuitry 508 was processing the next chunk, row R2, then the sparse dequantized data register 512 would store dequantized values for weights [b] and [c] and only have one address empty.

Next, the prefix sum circuitry 514 calculates the parallel prefix sum of the bitmask 506 to generate the expansion indices 516. The expansion indices 516 includes an array {0, 1, 0} which represent the first row of the bitmask 506. The array {0, 1, 0} are input to the multiplexers 518a, 518b, 518c. For example, “0” is input to multiplexer 518a, “1” is input to multiplexer 518b, and “0” is input to multiplexer 518c. Multiplexer 518a is an input to a first address of the dense dequantized data register 520, and the “0” causes the multiplexer to write a “0” to the first address of the dense dequantized data register 520. Multiplexer 518b is an input to a second address of the dense dequantized data register 520 and the “1” causes the multiplexer to select the first dequantized value of weight [a]. The multiplexer 518b writes the dequantized value of weight [a] to the second address of the dense dequantized data register 520. Lastly, multiplexer 518c is an input to a third address of the dense dequantized data register 520, and the “0” causes the multiplexer 518c to write a “0” to the third address of the dense dequantized data register 520. The locations of the zeros and nonzeros in the dense dequantized data register 520 are correct locations based on the original weight tile 502.

The dense dequantized data register 520 writes the dense dequantized chunk 522 to an example output register 524. The output register 524 may be implemented by the output register 218 of FIGS. 2, 3, and 4.

In some examples, the operation of the decompression accelerator pipeline 500 is repeated until each operation window of the weight tile 502 is decompressed into a chunk and stored in the output register 524. In some examples, when the output register 524 has all the chunks of the weight tile 502, a core, such as core 204 of FIGS. 2 and 3, consumes the weight tile 502.

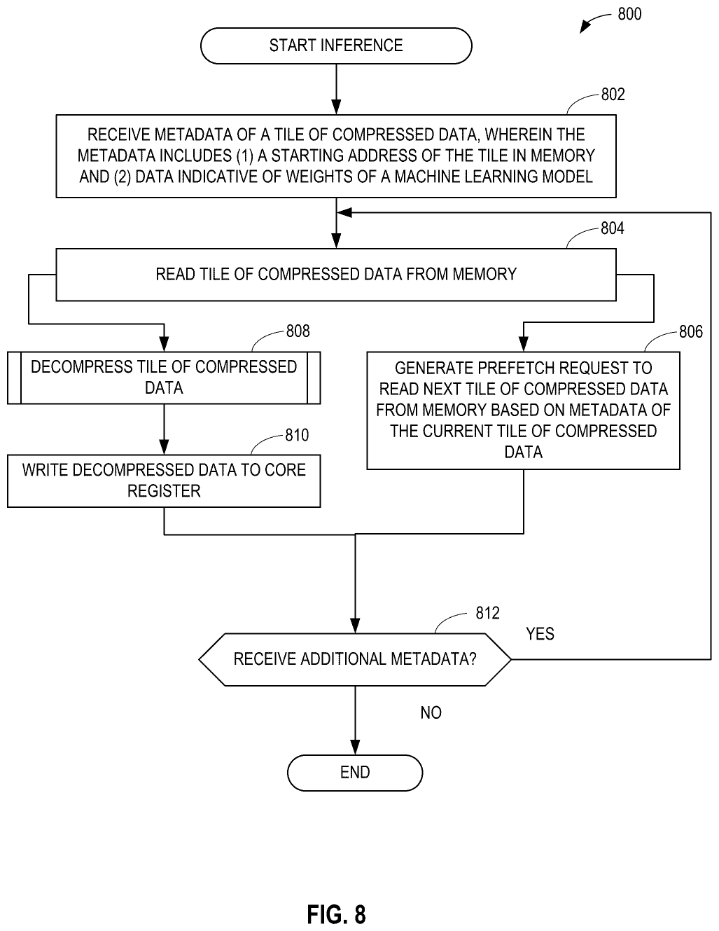

FIGS. 6 and 7 are bar charts 600 and 700 illustrating a performance of a core executing an inference workload using software decompression versus using the decompression accelerator 202 of FIGS. 2-4.

FIG. 6 is a first bar chart 600 representing data compression types versus a performance measurement. The data compression types are on the x-axis and represent a quantization (Qx) and a density (%) used to compress a weight tile. For example, Q16 refers to 16 quantized bits, Q8 refers to 8 quantized bits, and Q4 refers to 4 quantized bits. The percentages associated with each quantization scheme (Qx) refers to the fraction of nonzeros in the weight tile. For example, Q16 with 50% represents a weight tile with 16 bit quantization and 50% of the values in the weight tile are nonzeros. Q8 with 30% represents a weight tile with 8 bit quantization and 30% of the values in the weight tile are nonzeros, while the remaining 70% are zeros or near zero values.

The performance measurement is on the y-axis and numbered 0 through 10, where each number represents the performance improvement (e.g., speedup) during an inference with weight tiles having a compression type and decompressed using software decompression or the decompression accelerator 202. The speedups are calculated with respect to executing inference with a non-compressed model. For example, the baseline speedup 1 is the speed at which the processing engine 214 performs an inference of an AI model, where no weights are compressed. The speedup of 10 is a speed that is 10 times faster than the baseline speed and refers to the speed at which the processing engine 214 performs an inference of the AI model, where weights are compressed.

In FIG. 6, software decompression and the decompression accelerator 202 are simulated for an inference workload to decompress weight tiles compressed in the specific compression type. In the first bar chart 600, a first bar 602 represents a performance of the core executing an inference workload when software decompression is simulated. The first bar 602 is depicted by a dotted bar. In the first bar chart 600, a second bar 604 represents a performance of the core executing an inference workload when the decompression accelerator 202 (e.g., DECA) is simulated. The second bar 604 as a shaded in bar. In the first bar chart 600, a third bar 606 represents an optimal performance of the core executing an inference workload for each compression type. The third bar 606 is filled with diagonal lines.

In FIG. 6, the first bar chart 600 illustrates that using the decompression accelerator 202 for highly compressed data improves performance of the core significantly relative to using software decompression. At lower compression rates (e.g., Q16 with 50% density, Q8 with no sparsity, Q16 with 30% density, and Q8 with 50% density), the speedup is low, regardless of the type of decompression implemented. This is because lower compressed data requires more memory accesses to access all the data. The more a core has to access memory, the less the core can perform operations in a second. That is why the weights are compressed.

The first bar chart 600 illustrates that at higher compression rates (e.g., Q4, Q16 with 20% density, Q8 with 30% density, Q16 with 10% density, etc.), the speedup is high, but based on which decompression method is used. Here, the decompression accelerator 202 doubles performance of the core during an inference workload. For example, for weights compressed using 16 bit quantization and having 10% density, the core achieves an approximately 6× speedup when the decompression accelerator 202 is implemented and approximately 3× speedup when traditional software decompression is used. Although the first bar chart 600 illustrates specific compression rates and speedup rates, the decompression accelerator 202 may use any type of compression rate and the speedup rates may change based on the type of compression rate, the type of data being compressed, and many other factors such as resource usage of the system 200.

The first bar chart 600 illustrates that the performance of the core during an inference workload is optimal or approximately optimal when the decompression accelerator 202 is implemented. For example, for weights compressed using 8 bit quantization and having 20% density, the optimal speedup of the core is approximately 6.3 times (e.g., 6.3×). When the decompression accelerator 202 is implemented, the core performs approximately 6× for that compression type.

Therefore, the first bar chart 600 illustrates how the decompression accelerator 202 improves the performance of a core implementing an inference workload.

FIG. 7 is a second bar chart 700 representing active core count versus performance of a processing platform implementing artificial intelligence inference workloads. A processing platform may include a plurality of cores to implement an inference workload. The second bar chart 700 illustrates how decompression accelerator-augmented cores significantly reduce the number of cores needed to achieve maximum performance during an inference workload.

The x-axis of the second bar chart 700 represents a core count, illustrating how many cores are used to implement an AI model inference workload. For example, a processing platform may activate 8 cores, 16 cores, 24 cores, 32 cores, 40 cores, 48 cores, or 56 cores to execute an AI model inference workload.

The y-axis of the second bar chart 700 represents average TFLOPs the processing platform performed when implementing the inference workload. For example, the processing platform averages approximately 1.5 TFLOPs when 8 decompression accelerator-augmented cores are activated to execute an inference workload, and approximately 0.6 TFLOPs when software decompression-augmented cores are activated.

The second bar chart 700 illustrates that 16 decompression accelerator-augmented cores achieve greater performance than 56 cores without decompression accelerators. Therefore, the decompression accelerator either frees-up cores for other workloads that don't consume much memory bandwidth (e.g. microservices), or cores can be power-gated to save energy of the processing platform.

While an example manner of implementing the decompression accelerator 202 of FIG. 2 is illustrated in FIG. 4, one or more of the elements, processes, and/or devices illustrated in FIG. 4 may be combined, divided, re-arranged, omitted, eliminated, and/or implemented in any other way. Further, the example processing engine 214, the example control register(s) 216, the example output register(s) 218, the example dequantization circuitry 402, the example expansion circuitry 404, the example scaling circuitry 406, the example sparse quantized data register 408, the example bitmask queue 410, the example scale factor queue 412, the example population count circuitry 414, the example sparse dequantized data register 416, the example dense dequantized data register 418, the example load register 420, the example prefetch register 422, the example parallel prefix sum circuitry 426, the example multiplier 428, the example cross bar expansion circuitry 430, the example multipliers 432a-432W, and/or, more generally, the example decompression accelerator 202 of FIG. 4, may be implemented by hardware alone or by hardware in combination with software and/or firmware. Thus, for example, any of the example processing engine 214, the example control register(s) 216, the example output register(s) 218, the example dequantization circuitry 402, the example expansion circuitry 404, the example scaling circuitry 406, the example sparse quantized data register 408, the example bitmask queue 410, the example scale factor queue 412, the example population count circuitry 414, the example sparse dequantized data register 416, the example dense dequantized data register 418, the example load register 420, the example prefetch register 422, the example parallel prefix sum circuitry 426, the example multiplier 428, the example cross bar expansion circuitry 430, the example multipliers 432a-432W, and/or, more generally, the example decompression accelerator 202, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example decompression accelerator of FIG. 4 may include one or more elements, processes, and/or devices in addition to, or instead of, those illustrated in FIG. 4, and/or may include more than one of any or all of the illustrated elements, processes and devices.

Flowchart(s) representative of example machine readable instructions, which may be executed by programmable circuitry to implement and/or instantiate the decompression accelerator 202 of FIG. 4 and/or representative of example operations which may be performed by programmable circuitry to implement and/or instantiate the decompression accelerator 202 of FIG. 4, are shown in FIGS. 8 and 9. The machine readable instructions may be one or more executable programs or portion(s) of one or more executable programs for execution by programmable circuitry such as the programmable circuitry 1012 shown in the example processor platform 1000 discussed below in connection with FIG. 10 and/or may be one or more function(s) or portion(s) of functions to be performed by the example programmable circuitry (e.g., an FPGA) discussed below in connection with FIGS. 11 and/or 12. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8 and 9, many other methods of implementing the example decompression accelerator 202 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8 and 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 8 is a flowchart representative of example machine readable instructions and/or example operations 800 that may be executed, instantiated, and/or performed by programmable circuitry to decompress weight tiles for a processing core that is using the weight tiles to perform an inference workload. The example machine-readable instructions and/or the example operations 800 of FIG. 8 begin at block 802, at which the decompression accelerator 202 (FIGS. 2 and/or 4) receives metadata of a tile of compressed data, wherein the metadata includes (1) a starting address of the tile in memory and (2) data indicative of weights of a machine learning model. For example, the control register(s) 216 (FIGS. 2 and/or 4) obtain metadata from the core 204 (FIG. 2) including a starting address of a location in memory and the length of three data structures of the tile of compressed data. The three data structures are the data, the bitmask, and the scaling factors. The length of the three data structures is a number of bytes that the data structures occupy in memory (e.g., last level cache slice 206).

At block 804, the decompression accelerator 202 reads the tile of compressed data from memory. For example, the control register(s) 216 and/or the load register 420 (FIG. 4) reads the data, the bitmask, and the scaling factors from a level two cache (e.g. level two cache 210 of FIG. 2).

At block 806, the decompression accelerator 202 generates a prefetch request to read next tile of compressed data. For example, the prefetch register 422 (FIG. 4) records regular access patterns (e.g., patterns of lengths of data structures) issued by the load register 420 and predicts which data to prefetch from memory (e.g., the last level cache slice 206). For example, the prefetch register 422 observes the address bases and lengths used for the current tile and predicts the address bases and lengths for a next tile. In some examples, the prefetch register 422 causes the last level cache slice 206 to send the tile of compressed data, corresponding to the tile metadata, to the level two cache 210.

At block 808, the decompression accelerator 202 decompresses the tile of compressed data. For example, the processing engine 214 (FIGS. 2 and/or 4) dequantizes, desparsifies, and scales the tile of compressed data. The processing engine 214 decompresses the data in the tile while the prefetch register 422 prefetches the next tile of compressed data. For example, the operation of block 808 occurs simultaneously as the operations of block 806. By the time the loader register reads the next tile of compressed data from memory (block 804), the processing engine 214 has decompressed the current tile of compressed data and can decompress the next tile of compressed data. The operations of block 808 are described in further detail below in connection with FIG. 9.

At block 810, the decompression accelerator 202 writes the decompressed data to the processor core 204. For example, the output register 218 (FIGS. 2 and/or 4) writes the tile of decompressed data to a register at the core 204. The core 204 can then use the decompressed data, representative of an AI model weight, to perform an inference workload on an input.

At block 812, the decompression accelerator 202 determines whether the core 204 has sent additional metadata. For example, the control register(s) 216 and/or the load register 420 determines whether the core 204 has sent metadata of a tile of compressed data, including the data, the bitmask, and the scaling factors.

At block 812, if the decompression accelerator 202 determines that the core has sent additional metadata (e.g., block 812 returns a value YES), control returns to block 804 where the decompression accelerator 202 reads the tile of compressed data from memory. For example, the control register(s) 216 and/or the load register 420 reads the data, the bitmask, and the scaling factors from a level two cache (e.g. level two cache 210 of FIG. 2).

At block 812, if the decompression accelerator 202 determines that the core has not sent additional metadata (e.g., block 812 returns a value NO), the operations 800 end. For example, the operations 800 end when the core stops sending metadata to the decompression accelerator 202. The operations 800 may be repeated when a new inference workload is generated and/or new weights are compressed and added to the main memory (e.g., last level cache slice 206).

FIG. 9 is a flowchart representative of example machine readable instructions and/or example operations 808 of FIG. 8 that may be executed, instantiated, and/or performed by programmable circuitry to decompress a tile of compressed data. The example machine-readable instructions and/or the example operations 808 of FIG. 9 begin at block 902, at which the processing engine 214 (FIG. 4) reads a window of elements of compressed data. For example, the sparse quantized data register 408 reads the compressed data from the load register 420. The population count circuitry 414 denotes a window of elements of compressed data that the decompression accelerator 202 is to decompress.

At block 904, the processing engine 214 dequantizes the elements of compressed data using lookup tables to generate sparse dequantized data. For example, the dequantization circuitry 402 (FIG. 4) uses an LUT array 424 (FIG. 4) to dequantize the compressed elements that will produce a chunk of W uncompressed elements. The LUT array 424 includes the lookup tables having data that maps input values to output values, thereby approximating some function (e.g., quantization). For example, the one or more lookup tables can be used to map a quantized value in the compressed data to a dequantized value.

At block 906, the processing engine 214 inserts zeros among the sparse dequantized data in positions identified by one or more bitmasks associated with the sparse dequantized data to generate dense dequantized data. For example, the expansion circuitry 404 (FIG. 4) calculates a parallel prefix sum from the bitmask using the prefix sum circuitry 426, wherein the parallel prefix sum determines a number of nonzeros in the bitmask, which can be used to indicate the locations of the nonzeros when multiplied with the bitmask. When locations of the nonzeros are identified, the expansion circuitry 404 uses the cross bar expansion circuitry 430 (FIG. 4) to insert the zeros into the remaining positions of the sparse dequantized data. The result is W elements of dense dequantized data.

At block 908, the processing engine 214 multiplies the dense dequantized data with respective scaling factors to generate decompressed data. For example, the scaling circuitry 406 (FIG. 4) includes multipliers 432a-432W (FIG. 4) that scale values (e.g., nonzero values) in the dense dequantized data register 418 by multiplying an element with respective scaling factor. The result of applying respective scaling factors (if there are any) is a final decompressed chunk of data.

At block 910, the processing engine 214 writes the chunk of decompressed data to the output register 218 (FIG. 4) to be processed by the processor core 204 (FIGS. 2 and/or 3). For example, the scaling circuitry 406 writes the final values to the output register 218, wherein the output register 218 stores final values in chunks (e.g., chunks of W elements) until a complete tile is decompressed.

At block 912, the processing engine 214 determines whether an additional window of elements of compressed data is in the tile. For example, the population count circuitry 414 denotes current windows of elements that still need to be decompressed. The population count circuitry 414 uses the bitmask to count a number of 1 bits in the tile of compressed data, which can be used to inform the dequantization circuitry 402 where the next nonzero element is and/or if there are any elements of compressed data remaining in the tile.

At block 912, if the processing engine 214 determines that additional window of elements of compressed data is in the tile (e.g., block 912 returns a value YES), then control returns to block 902 where the processing engine 214 and/or the sparse quantized data register 408 reads the compressed data from the load register 420.

At block 912, if the processing engine 214 determines that there is not an additional window of elements of compressed data in the tile (e.g., block 912 returns a value NO), control returns to block 816 of the operations of FIG. 8, where the decompression accelerator 202 writes decompressed data to a register of the core 204. For example, the output register 218 transfers the tile of decompressed data to a core tile register at the core 204, where it can be consumed by a matrix multiplication operation.

FIG. 10 is a block diagram of an example programmable circuitry platform 1000 structured to execute and/or instantiate the example machine-readable instructions and/or the example operations of FIGS. 8 and 9 to implement the system 200 and decompression accelerator 202 of FIGS. 2 and 4. The programmable circuitry platform 1000 can be, for example, a server, a personal computer, a workstation, a self-learning machine (e.g., a neural network), a mobile device (e.g., a cell phone, a smart phone, a tablet such as an iPad™), a headset (e.g., an augmented reality (AR) headset, a virtual reality (VR) headset, etc.) or other wearable device, or any other type of computing and/or electronic device.

The programmable circuitry platform 1000 of the illustrated example includes programmable circuitry 1012. The programmable circuitry 1012 of the illustrated example is hardware. For example, the programmable circuitry 1012 can be implemented by one or more integrated circuits, logic circuits, FPGAs, microprocessors, CPUs, GPUs, DSPs, and/or microcontrollers from any desired family or manufacturer. The programmable circuitry 1012 may be implemented by one or more semiconductor based (e.g., silicon based) devices. In this example, the programmable circuitry 1012 implements the example decompression accelerator 202, the example core 204, the example processing engine 214, the example dequantization circuitry 402, the example lookup table (LUT) array 424, the example expansion circuitry 404, the example parallel prefix sum circuitry 426, the example multiplier 428, the example cross bar expansion circuitry 430, the example population count circuitry 414, the example scaling circuitry 406, and the example multipliers 432.

The programmable circuitry 1012 of the illustrated example includes a local memory 1013 (e.g., a cache, registers, etc.). In this example, the local memory 1013 implements the example control register(s) 216, the example output register(s) 218, the example load register 420, the example prefetch register 422, the example sparse quantized data (SQD) register 408, the example bitmask queue 410, the example scale factor queue 412, the example sparse dequantized data (SDD) register 416, and the example dense dequantized data (DDD) register 418 of FIGS. 2 and 4.

The programmable circuitry 1012 of the illustrated example is in communication with main memory 1014, 1016, which includes a volatile memory 1014 and a non-volatile memory 1016, by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. In this example, the main memory 1014, 1016 implements the example last level cache (LLC) 206, the example level two cache 210, and the example level one cache 212 of FIG. 2.

Access to the main memory 1014, 1016 of the illustrated example is controlled by a memory controller 1017. In some examples, the memory controller 1017 may be implemented by one or more integrated circuits, logic circuits, microcontrollers from any desired family or manufacturer, or any other type of circuitry to manage the flow of data going to and from the main memory 1014, 1016. In this example, the memory controller 1017 implements the example router 208 of FIG. 2.

The programmable circuitry platform 1000 of the illustrated example also includes interface circuitry 1020. The interface circuitry 1020 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1022 are connected to the interface circuitry 1020. The input device(s) 1022 permit(s) a user (e.g., a human user, a machine user, etc.) to enter data and/or commands into the programmable circuitry 1012. The input device(s) 1022 can be implemented by, for example a keyboard, a button, a mouse, a touchscreen, a trackpad, a trackball, an isopoint device, and/or a voice recognition system.

One or more output devices 1024 are also connected to the interface circuitry 1020 of the illustrated example. The output device(s) 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1000 of the illustrated example also includes one or more mass storage discs or devices 1028 to store firmware, software, and/or data. Examples of such mass storage discs or devices 1028 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1032, which may be implemented by the machine readable instructions of FIGS. 8 and 9, may be stored in the mass storage device 1028, in the volatile memory 1014, in the non-volatile memory 1016, and/or on at least one non-transitory computer readable storage medium such as a CD or DVD which may be removable.

FIG. 11 is a block diagram of an example implementation of the programmable circuitry 1012 of FIG. 10. In this example, the programmable circuitry 1012 of FIG. 10 is implemented by a microprocessor 1100. For example, the microprocessor 1100 may be a general-purpose microprocessor (e.g., general-purpose microprocessor circuitry). The microprocessor 1100 executes some or all of the machine-readable instructions of the flowcharts of FIGS. 8 and 9 to effectively instantiate the circuitry of FIGS. 2 and 4 as logic circuits to perform operations corresponding to those machine readable instructions. In some such examples, the circuitry of FIGS. 2 and 4 is instantiated by the hardware circuits of the microprocessor 1100 in combination with the machine-readable instructions. For example, the microprocessor 1100 may be implemented by multi-core hardware circuitry such as a CPU, a DSP, a GPU, an XPU, etc. Although it may include any number of example cores 1102 (e.g., 1 core), the microprocessor 1100 of this example is a multi-core semiconductor device including N cores. The cores 1102 of the microprocessor 1100 may operate independently or may cooperate to execute machine readable instructions. For example, machine code corresponding to a firmware program, an embedded software program, or a software program may be executed by one of the cores 1102 or may be executed by multiple ones of the cores 1102 at the same or different times. In some examples, the machine code corresponding to the firmware program, the embedded software program, or the software program is split into threads and executed in parallel by two or more of the cores 1102. The software program may correspond to a portion or all of the machine readable instructions and/or operations represented by the flowcharts of FIGS. 8 and 9.

The cores 1102 may communicate by a first example bus 1104. In some examples, the first bus 1104 may be implemented by a communication bus to effectuate communication associated with one(s) of the cores 1102. For example, the first bus 1104 may be implemented by at least one of an Inter-Integrated Circuit (I2C) bus, a Serial Peripheral Interface (SPI) bus, a PCI bus, or a PCIe bus. Additionally or alternatively, the first bus 1104 may be implemented by any other type of computing or electrical bus. The cores 1102 may obtain data, instructions, and/or signals from one or more external devices by example interface circuitry 1106. The cores 1102 may output data, instructions, and/or signals to the one or more external devices by the interface circuitry 1106. Although the cores 1102 of this example include example local memory 1120 (e.g., Level 1 (L1) cache that may be split into an L1 data cache and an L1 instruction cache), the microprocessor 1100 also includes example shared memory 1110 that may be shared by the cores (e.g., Level 2 (L2 cache)) for high-speed access to data and/or instructions. Data and/or instructions may be transferred (e.g., shared) by writing to and/or reading from the shared memory 1110. The local memory 1120 of each of the cores 1102 and the shared memory 1110 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1102 may be referred to as a CPU, DSP, GPU, etc., or any other type of hardware circuitry. Each core 1102 includes control unit circuitry 1114, arithmetic and logic (AL) circuitry (sometimes referred to as an ALU) 1116, a plurality of registers 1118, the local memory 1120, and a second example bus 1122. Other structures may be present. For example, each core 1102 may include vector unit circuitry, single instruction multiple data (SIMD) unit circuitry, load/store unit (LSU) circuitry, branch/jump unit circuitry, floating-point unit (FPU) circuitry, etc. The control unit circuitry 1114 includes semiconductor-based circuits structured to control (e.g., coordinate) data movement within the corresponding core 1102. The AL circuitry 1116 includes semiconductor-based circuits structured to perform one or more mathematic and/or logic operations on the data within the corresponding core 1102. The AL circuitry 1116 of some examples performs integer based operations. In other examples, the AL circuitry 1116 also performs floating-point operations. In yet other examples, the AL circuitry 1116 may include first AL circuitry that performs integer-based operations and second AL circuitry that performs floating-point operations. In some examples, the AL circuitry 1116 may be referred to as an Arithmetic Logic Unit (ALU).

The registers 1118 are semiconductor-based structures to store data and/or instructions such as results of one or more of the operations performed by the AL circuitry 1116 of the corresponding core 1102. For example, the registers 1118 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1118 may be arranged in a bank as shown in FIG. 11. Alternatively, the registers 1118 may be organized in any other arrangement, format, or structure, such as by being distributed throughout the core 1102 to shorten access time. The second bus 1122 may be implemented by at least one of an I2C bus, a SPI bus, a PCI bus, or a PCIe bus.

Each core 1102 and/or, more generally, the microprocessor 1100 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1100 is a semiconductor device fabricated to include many transistors interconnected to implement the structures described above in one or more integrated circuits (ICs) contained in one or more packages.

The microprocessor 1100 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1100, in the same chip package as the microprocessor 1100 and/or in one or more separate packages from the microprocessor 1100.

FIG. 12 is a block diagram of another example implementation of the programmable circuitry 1012 of FIG. 10. In this example, the programmable circuitry 1012 is implemented by FPGA circuitry 1200. For example, the FPGA circuitry 1200 may be implemented by an FPGA. The FPGA circuitry 1200 can be used, for example, to perform operations that could otherwise be performed by the example microprocessor 1100 of FIG. 11 executing corresponding machine readable instructions. However, once configured, the FPGA circuitry 1200 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1100 of FIG. 11 described above (which is a general purpose device that may be programmed to execute some or all of the machine readable instructions represented by the flowchart(s) of FIGS. 8 and 9 but whose interconnections and logic circuitry are fixed once fabricated), the FPGA circuitry 1200 of the example of FIG. 12 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8 and 9. In particular, the FPGA circuitry 1200 may be thought of as an array of logic gates, interconnections, and switches. The switches can be programmed to change how the logic gates are interconnected by the interconnections, effectively forming one or more dedicated logic circuits (unless and until the FPGA circuitry 1200 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8 and 9. As such, the FPGA circuitry 1200 may be configured and/or structured to effectively instantiate some or all of the operations/functions corresponding to the machine readable instructions of the flowchart(s) of FIGS. 8 and 9 as dedicated logic circuits to perform the operations/functions corresponding to those software instructions in a dedicated manner analogous to an ASIC. Therefore, the FPGA circuitry 1200 may perform the operations/functions corresponding to the some or all of the machine readable instructions of FIGS. 8 and 9 faster than the general-purpose microprocessor can execute the same.

In the example of FIG. 12, the FPGA circuitry 1200 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1200 of FIG. 12 may access and/or load the binary file to cause the FPGA circuitry 1200 of FIG. 12 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1200 of FIG. 12 to cause configuration and/or structuring of the FPGA circuitry 1200 of FIG. 12, or portion(s) thereof.

The FPGA circuitry 1200 of FIG. 12, includes example input/output (I/O) circuitry 1202 to obtain and/or output data to/from example configuration circuitry 1204 and/or external hardware 1206. For example, the configuration circuitry 1204 may be implemented by interface circuitry that may obtain a binary file, which may be implemented by a bit stream, data, and/or machine-readable instructions, to configure the FPGA circuitry 1200, or portion(s) thereof. In some such examples, the configuration circuitry 1204 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1206 may be implemented by external hardware circuitry. For example, the external hardware 1206 may be implemented by the microprocessor 1100 of FIG. 11.

The FPGA circuitry 1200 also includes an array of example logic gate circuitry 1208, a plurality of example configurable interconnections 1210, and example storage circuitry 1212. The logic gate circuitry 1208 and the configurable interconnections 1210 are configurable to instantiate one or more operations/functions that may correspond to at least some of the machine readable instructions of FIGS. 8 and 9 and/or other desired operations. The logic gate circuitry 1208 shown in FIG. 12 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1208 to enable configuration of the electrical structures and/or the logic gates to form circuits to perform desired operations/functions. The logic gate circuitry 1208 may include other electrical structures such as look-up tables (LUTs), registers (e.g., flip-flops or latches), multiplexers, etc.

The configurable interconnections 1210 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1208 to program desired logic circuits.

The storage circuitry 1212 of the illustrated example is structured to store result(s) of the one or more of the operations performed by corresponding logic gates. The storage circuitry 1212 may be implemented by registers or the like. In the illustrated example, the storage circuitry 1212 is distributed amongst the logic gate circuitry 1208 to facilitate access and increase execution speed.

The example FPGA circuitry 1200 of FIG. 12 also includes example dedicated operations circuitry 1214. In this example, the dedicated operations circuitry 1214 includes special purpose circuitry 1216 that may be invoked to implement commonly used functions to avoid the need to program those functions in the field. Examples of such special purpose circuitry 1216 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1200 may also include example general purpose programmable circuitry 1218 such as an example CPU 1220 and/or an example DSP 1222. Other general purpose programmable circuitry 1218 may additionally or alternatively be present such as a GPU, an XPU, etc., that can be programmed to perform other operations.

Although FIGS. 11 and 12 illustrate two example implementations of the programmable circuitry 1012 of FIG. 10, many other approaches are contemplated. For example, FPGA circuitry may include an on-board CPU, such as one or more of the example CPU 1220 of FIG. 11. Therefore, the programmable circuitry 1012 of FIG. 10 may additionally be implemented by combining at least the example microprocessor 1100 of FIG. 11 and the example FPGA circuitry 1200 of FIG. 12. In some such hybrid examples, one or more cores 1102 of FIG. 11 may execute a first portion of the machine readable instructions represented by the flowchart(s) of FIGS. 8 and 9 to perform first operation(s)/function(s), the FPGA circuitry 1200 of FIG. 12 may be configured and/or structured to perform second operation(s)/function(s) corresponding to a second portion of the machine readable instructions represented by the flowcharts of FIGS. 8 and 9, and/or an ASIC may be configured and/or structured to perform third operation(s)/function(s) corresponding to a third portion of the machine readable instructions represented by the flowcharts of FIGS. 8 and 9.

It should be understood that some or all of the circuitry of FIGS. 2 and 4 may, thus, be instantiated at the same or different times. For example, same and/or different portion(s) of the microprocessor 1100 of FIG. 11 may be programmed to execute portion(s) of machine-readable instructions at the same and/or different times. In some examples, same and/or different portion(s) of the FPGA circuitry 1200 of FIG. 12 may be configured and/or structured to perform operations/functions corresponding to portion(s) of machine-readable instructions at the same and/or different times.

In some examples, some or all of the circuitry of FIGS. 2 and 4 may be instantiated, for example, in one or more threads executing concurrently and/or in series. For example, the microprocessor 1100 of FIG. 11 may execute machine readable instructions in one or more threads executing concurrently and/or in series. In some examples, the FPGA circuitry 1200 of FIG. 12 may be configured and/or structured to carry out operations/functions concurrently and/or in series. Moreover, in some examples, some or all of the circuitry of FIGS. 2 and 4 may be implemented within one or more virtual machines and/or containers executing on the microprocessor 1100 of FIG. 11.

In some examples, the programmable circuitry 1012 of FIG. 10 may be in one or more packages. For example, the microprocessor 1100 of FIG. 11 and/or the FPGA circuitry 1200 of FIG. 12 may be in one or more packages. In some examples, an XPU may be implemented by the programmable circuitry 1012 of FIG. 10, which may be in one or more packages. For example, the XPU may include a CPU (e.g., the microprocessor 1100 of FIG. 11, the CPU 1220 of FIG. 12, etc.) in one package, a DSP (e.g., the DSP 1222 of FIG. 12) in another package, a GPU in yet another package, and an FPGA (e.g., the FPGA circuitry 1200 of FIG. 12) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve a performance of a core processing weights of an artificial intelligence model by implementing a decompression accelerator per core in a processing platform. The decompression accelerator implements double buffering to increase the amount of compressed weights that can be decompressed at a time. The decompression accelerator additionally selects a number of lookup tables to implement based on a size of a tile to efficiently decompresses the compressed weights. Disclosed systems, apparatus, articles of manufacture, and methods improve the efficiency of using a computing device by reducing the number of cores needed to achieve maximum performance of a processing platform during an inference workload. For example, the decompression accelerator either frees-up cores for other workloads that don't consume much memory bandwidth (e.g. microservices), or cores can be power-gated to save energy of the processing platform. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for a machine learning model decompression accelerator are disclosed herein. Further examples and combinations thereof include the following:

Example 1 includes an apparatus comprising a processor core including at least one matrix multiplication engine, memory storing a plurality of tiles of compressed data of a machine learning model to be processed by the at least one matrix multiplication engine, and a decompression accelerator including one or more control registers in communication with the processor core, a processing engine in communication with the memory and configured by the one or more control registers to decompress the plurality of tiles of the compressed data, and an output register to store decompressed data, wherein the processor core is to read the decompressed data from the output register and cause the at least one matrix multiplication engine to perform matrix multiplication with the decompressed data for execution of the machine learning model.

Example 2 includes the apparatus of example 1, wherein the one or more control registers include loader circuitry to read a first tile of the plurality of tiles of the compressed data of the machine learning model from the memory, and prefetch a second tile of the plurality of tiles of the compressed data of the machine learning model from a main memory based on a pattern of tile accesses by the processing engine, wherein the processing engine decompresses the first tile of the compressed data while the loader circuitry reads the second tile from the memory.

Example 3 includes the apparatus of example 1, wherein a first tile of the plurality of tiles of the compressed data includes a plurality of elements of compressed weights, one or more bitmasks, and one or more scaling factors and the processing engine further includes dequantization circuitry to generate sparse dequantized data by dequantizing the compressed weights using a lookup table.

Example 4 includes the apparatus of example 3, wherein the processing engine further includes a sparse quantized queue to store the elements of compressed weights, and population count circuitry to determine a current operation window in the sparse quantized queue based on counting a number of one bits in the one or more bitmasks, wherein the current operation window informs the dequantization circuitry which elements of compressed weights are to be dequantized.

Example 5 includes the apparatus of example 1, wherein a first tile of the plurality of tiles of the compressed data includes a plurality of elements of compressed weights, one or more bitmasks, and one or more scaling factors and the processing engine further includes a bitmask queue to store the one or more bitmasks, a sparse dequantized data register to store sparse dequantized data, and expansion circuitry to generate dense dequantized data from the sparse dequantized data by inserting zeros among the sparse dequantized data in positions identified by the one or more bitmasks associated with the sparse dequantized data.

Example 6 includes the apparatus of example 5, wherein the expansion circuitry includes parallel prefix sum circuitry to determine a number of nonzero values in the one or more bitmasks based on a parallel prefix sum of one of the one or more bitmasks, and a multiplier to multiply the parallel prefix sum by the one of the one or more bitmasks to indicate the positions in the sparse dequantized data to insert the zeros.

Example 7 includes the apparatus of example 1, wherein a first tile of the plurality of tiles of the compressed data includes a plurality of elements of compressed weights, one or more bitmasks, and one or more scaling factors and the processing engine further includes a scale factor queue to store the one or more scaling factors, a dense dequantized data register to store dense dequantized data of the first tile, and scaling circuitry to generate a decompressed output tile by multiplying the dense dequantized data with the one or more scaling factors and write the decompressed output tile to the output register.

Example 8 includes a decompression accelerator comprising one or more control registers in communication with a processor core including at least one matrix multiplication engine, a processing engine in communication with memory and configured by the one or more control registers to decompress a plurality of tiles of compressed data of a machine learning model, and an output register to store decompressed data, wherein the processor core is to read the decompressed data from the output register and perform matrix multiplication operations with the decompressed data for execution of the machine learning model.

Example 9 includes the decompression accelerator of example 8, wherein the one or more control registers include loader circuitry to read a first tile of the plurality of tiles of the compressed data of the machine learning model from the memory, and prefetch a second tile of the plurality of tiles of the compressed data of the machine learning model from a main memory based on a pattern of tile accesses by the processing engine, wherein the processing engine decompresses the first tile of the compressed data while the loader circuitry reads the second tile from the memory.

Example 10 includes the decompression accelerator of example 8, wherein a first tile of the plurality of tiles of the compressed data includes a plurality of elements of compressed weights, one or more bitmasks, and one or more scaling factors and the processing engine further includes dequantization circuitry to generate sparse dequantized data by dequantizing the compressed weights using a lookup table.

Example 11 includes the decompression accelerator of example 10, wherein the processing engine further includes a sparse quantized queue to store the plurality of elements of compressed weights, and population count circuitry to determine a current operation window in the sparse quantized queue based on counting a number of one bits in the one or more bitmasks, wherein the current operation window informs the dequantization circuitry which elements of compressed weights are to be dequantized.

Example 12 includes the decompression accelerator of example 8, wherein a first tile of the plurality of tiles of the compressed data includes a plurality of elements of compressed weights, one or more bitmasks, and one or more scaling factors and the processing engine further includes a bitmask queue to store the one or more bitmasks, a sparse dequantized data register to store sparse dequantized data, and expansion circuitry to generate dense dequantized data from the sparse dequantized data by inserting zeros among the sparse dequantized data in positions identified by the one or more bitmasks associated with the sparse dequantized data.

Example 13 includes the decompression accelerator of example 12, wherein the expansion circuitry includes parallel prefix sum circuitry to determine a number of nonzero values in the one or more bitmasks based on a parallel prefix sum of one of the one or more bitmasks, and a multiplier to multiply the parallel prefix sum by the one of the one or more bitmasks to indicate the positions in the sparse dequantized data to insert the zeros.

Example 14 includes the decompression accelerator of example 8, wherein a first tile of the plurality of tiles of the compressed data includes a plurality of elements of compressed weights, one or more bitmasks, and one or more scaling factors and the processing engine further includes a scale factor queue to store the one or more scaling factors, a dense dequantized data register to store dense dequantized data of the first tile, and scaling circuitry to generate a decompressed output tile by multiplying the dense dequantized data with the one or more scaling factors and write the decompressed output tile to the output register to be used in a matrix multiplication operation.

Example 15 includes a non-transitory machine readable storage medium comprising instructions to cause programmable circuitry to at least cause one or more control registers to communicate with a processor core including at least one matrix multiplication engine, decompress a plurality of tiles of compressed data of a machine learning model, and cause an output register to store decompressed data, wherein the processor core is to read the decompressed data from the output register and perform matrix multiplication operations with the decompressed data for execution of the machine learning model.

Example 16 includes the non-transitory machine readable storage medium of example 15, wherein the instructions are to cause the programmable circuitry to read a first tile of the plurality of tiles of the compressed data of the machine learning model from memory, and prefetch a second tile of the plurality of tiles of the compressed data of the machine learning model from a main memory based on a pattern of tile accesses, wherein the programmable circuitry is to decompress the first tile of the compressed data in parallel to reading the second tile from the memory.

Example 17 includes the non-transitory machine readable storage medium of example 15, wherein a first tile of the plurality of tiles of the compressed data includes a plurality of elements of compressed weights, one or more bitmasks, and one or more scaling factors and the instructions are to cause the programmable circuitry to generate sparse dequantized data by dequantizing the compressed weights using a lookup table.

Example 18 includes the non-transitory machine readable storage medium of example 17, wherein the instructions are to cause the programmable circuitry to store the plurality of elements of compressed weights in a sparse quantized queue, and determine a current operation window in the sparse quantized queue based on counting a number of one bits in the one or more bitmasks, wherein the current operation window denotes which elements of compressed weights are to be dequantized.

Example 19 includes the non-transitory machine readable storage medium of example 15, wherein a first tile of the plurality of tiles of the compressed data includes a plurality of elements of compressed weights, one or more bitmasks, and one or more scaling factors and the instructions are to cause the programmable circuitry to store the one or more bitmasks in a bitmask queue, store sparse dequantized data in a sparse dequantized data register, and generate dense dequantized data from the sparse dequantized data by inserting zeros among the sparse dequantized data in positions identified by the one or more bitmasks associated with the sparse dequantized data.

Example 20 includes the non-transitory machine readable storage medium of example 19, wherein the instructions are to cause the programmable circuitry to determine a number of nonzero values in the one or more bitmasks based on a parallel prefix sum of one of the one or more bitmasks, and multiply the parallel prefix sum by the one of the one or more bitmasks to indicate the positions in the sparse dequantized data to insert the zeros.

Example 21 includes the non-transitory machine readable storage medium of example 15, wherein a first tile of the plurality of tiles of the compressed data includes a plurality of elements of compressed weights, one or more bitmasks, and one or more scaling factors and the instructions are to cause the programmable circuitry to store the one or more scaling factors in a scale factor queue, store dense dequantized data of the first tile in a dense dequantized data register, and generate a decompressed output tile by multiplying the dense dequantized data with the one or more scaling factors and write the decompressed output tile to the output register.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
a processor core including at least one matrix multiplication engine;
memory storing a plurality of tiles of compressed data of a machine learning model to be processed by the at least one matrix multiplication engine; and
a decompression accelerator including:
one or more control registers in communication with the processor core;
a processing engine in communication with the memory and configured by the one or more control registers to decompress the plurality of tiles of the compressed data; and
an output register to store decompressed data, wherein the processor core is to read the decompressed data from the output register and cause the at least one matrix multiplication engine to perform matrix multiplication with the decompressed data for execution of the machine learning model.

2. The apparatus of claim 1, wherein the one or more control registers include loader circuitry to:
read a first tile of the plurality of tiles of the compressed data of the machine learning model from the memory; and
prefetch a second tile of the plurality of tiles of the compressed data of the machine learning model from a main memory based on a pattern of tile accesses by the processing engine, wherein the processing engine decompresses the first tile of the compressed data while the loader circuitry reads the second tile from the memory.

3. The apparatus of claim 1, wherein a first tile of the plurality of tiles of the compressed data includes a plurality of elements of compressed weights, one or more bitmasks, and one or more scaling factors and the processing engine further includes dequantization circuitry to generate sparse dequantized data by dequantizing the compressed weights using a lookup table.

4. The apparatus of claim 3, wherein the processing engine further includes:
a sparse quantized queue to store the elements of compressed weights; and
population count circuitry to determine a current operation window in the sparse quantized queue based on counting a number of one bits in the one or more bitmasks, wherein the current operation window informs the dequantization circuitry which elements of compressed weights are to be dequantized.

5. The apparatus of claim 1, wherein a first tile of the plurality of tiles of the compressed data includes a plurality of elements of compressed weights, one or more bitmasks, and one or more scaling factors and the processing engine further includes:
a bitmask queue to store the one or more bitmasks;
a sparse dequantized data register to store sparse dequantized data; and
expansion circuitry to generate dense dequantized data from the sparse dequantized data by inserting zeros among the sparse dequantized data in positions identified by the one or more bitmasks associated with the sparse dequantized data.

6. The apparatus of claim 5, wherein the expansion circuitry includes:
parallel prefix sum circuitry to determine a number of nonzero values in the one or more bitmasks based on a parallel prefix sum of one of the one or more bitmasks; and
a multiplier to multiply the parallel prefix sum by the one of the one or more bitmasks to indicate the positions in the sparse dequantized data to insert the zeros.

7. The apparatus of claim 1, wherein a first tile of the plurality of tiles of the compressed data includes a plurality of elements of compressed weights, one or more bitmasks, and one or more scaling factors and the processing engine further includes:
a scale factor queue to store the one or more scaling factors;
a dense dequantized data register to store dense dequantized data of the first tile; and
scaling circuitry to generate a decompressed output tile by multiplying the dense dequantized data with the one or more scaling factors and write the decompressed output tile to the output register.

8. A decompression accelerator comprising:
one or more control registers in communication with a processor core including at least one matrix multiplication engine;
a processing engine in communication with memory and configured by the one or more control registers to decompress a plurality of tiles of compressed data of a machine learning model; and
an output register to store decompressed data, wherein the processor core is to read the decompressed data from the output register and perform matrix multiplication operations with the decompressed data for execution of the machine learning model.

9. The decompression accelerator of claim 8, wherein the one or more control registers include loader circuitry to:
read a first tile of the plurality of tiles of the compressed data of the machine learning model from the memory; and
prefetch a second tile of the plurality of tiles of the compressed data of the machine learning model from a main memory based on a pattern of tile accesses by the processing engine, wherein the processing engine decompresses the first tile of the compressed data while the loader circuitry reads the second tile from the memory.

10. The decompression accelerator of claim 8, wherein a first tile of the plurality of tiles of the compressed data includes a plurality of elements of compressed weights, one or more bitmasks, and one or more scaling factors and the processing engine further includes dequantization circuitry to generate sparse dequantized data by dequantizing the compressed weights using a lookup table.

11. The decompression accelerator of claim 10, wherein the processing engine further includes:
a sparse quantized queue to store the plurality of elements of compressed weights; and
population count circuitry to determine a current operation window in the sparse quantized queue based on counting a number of one bits in the one or more bitmasks, wherein the current operation window informs the dequantization circuitry which elements of compressed weights are to be dequantized.

12. The decompression accelerator of claim 8, wherein a first tile of the plurality of tiles of the compressed data includes a plurality of elements of compressed weights, one or more bitmasks, and one or more scaling factors and the processing engine further includes:
a bitmask queue to store the one or more bitmasks;
a sparse dequantized data register to store sparse dequantized data; and
expansion circuitry to generate dense dequantized data from the sparse dequantized data by inserting zeros among the sparse dequantized data in positions identified by the one or more bitmasks associated with the sparse dequantized data.

13. The decompression accelerator of claim 12, wherein the expansion circuitry includes:
parallel prefix sum circuitry to determine a number of nonzero values in the one or more bitmasks based on a parallel prefix sum of one of the one or more bitmasks; and
a multiplier to multiply the parallel prefix sum by the one of the one or more bitmasks to indicate the positions in the sparse dequantized data to insert the zeros.

14. The decompression accelerator of claim 8, wherein a first tile of the plurality of tiles of the compressed data includes a plurality of elements of compressed weights, one or more bitmasks, and one or more scaling factors and the processing engine further includes:
a scale factor queue to store the one or more scaling factors;
a dense dequantized data register to store dense dequantized data of the first tile; and
scaling circuitry to generate a decompressed output tile by multiplying the dense dequantized data with the one or more scaling factors and write the decompressed output tile to the output register to be used in a matrix multiplication operation.

15. A non-transitory machine readable storage medium comprising instructions to cause programmable circuitry to at least:
cause one or more control registers to communicate with a processor core including at least one matrix multiplication engine;
decompress a plurality of tiles of compressed data of a machine learning model; and
cause an output register to store decompressed data, wherein the processor core is to read the decompressed data from the output register and perform matrix multiplication operations with the decompressed data for execution of the machine learning model.

16. The non-transitory machine readable storage medium of claim 15, wherein the instructions are to cause the programmable circuitry to:
read a first tile of the plurality of tiles of the compressed data of the machine learning model from memory; and
prefetch a second tile of the plurality of tiles of the compressed data of the machine learning model from a main memory based on a pattern of tile accesses, wherein the programmable circuitry is to decompress the first tile of the compressed data in parallel to reading the second tile from the memory.

17. The non-transitory machine readable storage medium of claim 15, wherein a first tile of the plurality of tiles of the compressed data includes a plurality of elements of compressed weights, one or more bitmasks, and one or more scaling factors and the instructions are to cause the programmable circuitry to generate sparse dequantized data by dequantizing the compressed weights using a lookup table.

18. The non-transitory machine readable storage medium of claim 17, wherein the instructions are to cause the programmable circuitry to:
store the plurality of elements of compressed weights in a sparse quantized queue; and
determine a current operation window in the sparse quantized queue based on counting a number of one bits in the one or more bitmasks, wherein the current operation window denotes which elements of compressed weights are to be dequantized.

19. The non-transitory machine readable storage medium of claim 15, wherein a first tile of the plurality of tiles of the compressed data includes a plurality of elements of compressed weights, one or more bitmasks, and one or more scaling factors and the instructions are to cause the programmable circuitry to:
store the one or more bitmasks in a bitmask queue;
store sparse dequantized data in a sparse dequantized data register; and
generate dense dequantized data from the sparse dequantized data by inserting zeros among the sparse dequantized data in positions identified by the one or more bitmasks associated with the sparse dequantized data.

20. The non-transitory machine readable storage medium of claim 19, wherein the instructions are to cause the programmable circuitry to:
determine a number of nonzero values in the one or more bitmasks based on a parallel prefix sum of one of the one or more bitmasks; and
multiply the parallel prefix sum by the one of the one or more bitmasks to indicate the positions in the sparse dequantized data to insert the zeros.

21. (canceled)
